(19) United States
(12) Patent Application Publication
(10) Pub. No.: US 2025/0272960 A1
(43) Pub. Date: Aug. 28, 2025

(54) LONG-TAILED ANOMALY DETECTION IN IMAGES

(71) Applicant: Mitsubishi Electric Research Laboratories, Inc., Cambridge, MA (US)

(72) Inventors: Kuan-Chuan Peng, Charleston, MA (US); Chih-Hui Ho, San Diego, CA (US)

(73) Assignee: Mitsubishi Electric Research Laboratories, Inc., Cambridge, MA (US)

(21) Appl. No.: 18/590,210

(22) Filed: Feb. 28, 2024

(51) Int. Cl. G06V 10/774; G06T 7/00; G06V 10/26; G06V 10/764; G06V 10/776; G06V 10/82

(52) U.S. Cl. CPC G06V 10/774; G06T 7/0002; G06V 10/26; G06V 10/764; G06V 10/776; G06V 10/82; G06T 2207/20081; G06T 2207/20084

(57) ABSTRACT

Embodiments of the present disclosure provide a method for anomaly detection in a patch of an image. The method comprises collecting a first text encoding of a first text prompt in a latent space, collecting a second text encoding of a second text prompt in the latent space, encoding the image to produce features of the image, partitioning the features of the image into feature patches, projecting each of the feature patches into the latent space using a projector operator, and comparing the projection of each of the feature patches with the first text encoding and the second text encoding to detect the anomaly when the projection of a feature patch from the feature patches is closer to the second text encoding than to the first text encoding.

### TECHNOLOGICAL FIELD

The present disclosure relates generally to training and use of machine learning systems for image processing, and more particularly to systems and methods for long-tailed anomaly detection in images with learnable class names.

### BACKGROUND

Anomaly detection techniques are utilized to identify defective images and localize defects (if any) within images. The defective images may then be used to identify and remove defective products and/or implement corrective measures to repair the defective products. In the realm of image processing and anomaly detection, traditional approaches have predominantly relied on specialized models tailored to individual object classes for performing anomaly detection. Anomaly detection is an important problem for many manufacturing settings, such as printed circuit board (PCB) manufacturing, semiconductor manufacturing, automobile parts manufacturing, and other product manufacturing.

Anomaly detection techniques require models to discern abnormal patterns by understanding the normal behavior or appearance. To reflect practical manufacturing constraints, most datasets are curated under an unsupervised anomaly detection setting where no defect images are available for training. When the models are exclusively trained on datasets featuring defect-free images, their capacity to recognize and characterize anomalies in real-world scenarios is compromised.

In certain cases, accuracy of models may be improved by training the models on a specialized dataset, such as MVTec dataset having real world normal images for training and a combination of normal and abnormal images for testing. However, techniques using the specialized dataset for training may still require a different model per image category, i.e., different model for each class of object in images. To this end, scalability of the model is limited.

Some methods of anomaly detection often suffer from a lack of generalization when confronted with novel or anomalous patterns not encountered during training. This deficiency becomes especially pronounced in applications where the consequences of overlooking defects may be critical, such as in medical diagnostics, industrial quality control, or security surveillance.

Accordingly, there is a need for a generalized and robust anomaly detection model to overcome the above mentioned challenges for the detection of an anomaly in various object classes in an efficient and accurate manner.

### SUMMARY

It is an object of some embodiments to employ an anomaly detector for detection of an anomaly in an image and localize the anomaly within the image. It is another object of some embodiments to perform long-tailed anomaly detection (LTAD) to detect defects for multiple and long-tailed classes, without relying on dataset class names.

Some embodiments are based on the recognition that anomaly detection models must be able to detect defects over many image classes without relying on hard-coded class names that may be uninformative or inconsistent across datasets. In particular, the anomaly detection models may have to be capable of learning without supervision and be robust to the long-tailed distributions of real-world applications.

Some embodiments are based on the realization that traditional techniques that use a single model to detect anomalies across different object classes may be grouped into two groups according to a level of image semantics on which the model operates.

In one example, anomaly detection may be performed using a model that uses a reconstruction technique to project an input image into a manifold of normal images. Further, a difference between the input image and the projection of the input image into the manifold is used to detect possible anomalies or defects in the input image.

In another example, anomaly detection may be performed using a model that uses a semantic technique. The semantic technique may be used to build explicit models of normal and abnormal classification. Due to the absence of abnormal images in training data, the model for abnormal classification is trained by leveraging the knowledge of a visual-language foundation model. The model may then detect normal and abnormal regions using predefined text prompts. The text prompts may correspond to a classification of normal or abnormal and an image class name associated with the images in training dataset. The prompts may be given as, for example, “a normal photo of a [CLASS]” and “an abnormal photo of a [CLASS]” where [CLASS] is a class name in the dataset, such as in the training dataset.

While the reconstruction techniques and the semantic techniques enable some generalization over object classes, these techniques have a number of limitations. For example, the model based on the reconstruction technique is required to model a manifold of complex normal images, especially for a variety of classes. Moreover, even when the model is trained on large datasets, a distance between a projection of an input image and the manifold of normal images may be smaller for certain regions having anomalies. In other words, the model trained on large dataset of normal images using the reconstruction techniques may be inaccurate in detecting anomalies within input images.

Further, the visual-language foundation model used by the semantic technique-based model may provide clarity by enabling framing of anomaly detection problem as a binary classification problem. However, solving such anomaly detection problem is difficult when class names in a dataset are ambiguous or unknown to the visual-language foundation model. To this end, the semantic technique-based model may rely on accuracy and reliability of class names learnt by the visual-language foundation model for anomaly detection. To this end, in cases where learning class names may be difficult, output of the semantic technique-based model may also be inaccurate and unreliable.

Further, the models based on reconstruction technique or the semantic technique, fail to generalize over long-tailed setting where sample distribution is skewed. Long-tailed distribution of images of different classes occur naturally in real-world scenarios, such as manufacturing. In the long-tailed distribution, different objects or object classes may have very different popularity. In other words, long-tailed distribution may occur when different number of images corresponding to different object classes may vary significantly.

Some embodiments are based on a recognition that existing systems for anomaly detection assume that different image classes are equally populated.

Some embodiments are based on a realization that in most industrial applications, different objects have different costs, production schedules, etc. This creates long-tailed distributions where certain classes have much higher example cardinality than others.

Some embodiments are based on a realization that anomaly detection systems not trained to account for this class imbalance tend to overfit on popular classes and ignore the less popular classes.

Accordingly, it is an objective of some embodiments of the present disclosure to provide a model for anomaly detection that combines both reconstruction technique and semantic technique for performing anomaly detection.

It is another objective of some embodiments of the present disclosure to formulate a problem of long-tailed anomaly detection (LTAD) by introducing several long-tailed datasets. Such long-tailed datasets may be obtained by resampling current anomaly detection benchmarks with different levels of class imbalance, different imbalance factors and different types of imbalances. Some embodiments may provide a set of performance metrics for the evaluation of the long-tailed setting.

Some embodiments may provide an LTAD method to detect defects from multiple and long-tailed classes without relying on dataset class names. In an example, the LTAD method combines anomaly detection by reconstruction techniques and semantic techniques. The LTAD method may implement the reconstruction technique using a transformer-based reconstruction model. On the other hand, the LTAD method may implement the semantic technique using a binary classifier that relies on learned pseudo class names and a pretrained visual-language foundation model.

In some embodiments, the LTAD method includes training a model in two phases. In a first phase or phase 1, the model learns pseudo-class names and a variational autoencoder (VAE) for feature synthesis. In this manner, training data is augmented to combat long-tailed dataset. Further, in a second phase or phase 2, the model learns parameters of reconstruction and classification modules of LTAD.

Accordingly, an embodiment of the present disclosure provides a computer-implemented method for detecting an anomaly in a patch of an image. The method uses a processor coupled with stored instructions implementing steps of the method. The method includes collecting a first text encoding of a first text prompt in a latent space, collecting a second text encoding of a second text prompt in the latent space, encoding the image to produce features of the image, and partitioning the features of the image into feature patches. The method further includes projecting each of the feature patches into the latent space using a projector operator, and comparing the projection of each of the feature patches with the first text encoding and the second text encoding to detect the anomaly when the projection of a feature patch from the feature patches is closer to the second text encoding than to the first text encoding. The projector operator is trained to project normal feature patches of normal images closer to the first text encoding than to the second text encoding while projecting noisy feature patches of the normal images closer to the second text encoding than to the first text encoding.

According to some embodiments, an image encoder is trained to encode global features of the image into the latent space shared by the image encoder and a text encoder of a visual-language foundation model.

According to some embodiments, the method further includes collecting a plurality of normal images associated with a class, encoding the plurality of normal images to produce features of the plurality of normal images using the image encoder, processing the features of the plurality of normal images conditioned on a pseudo class name associated with the class using an image decoder, and training the image decoder to learn the pseudo class name as the first text encoding. In an example, the pseudo class name is the first text prompt.

According to some embodiments, the method further includes obtaining encodings of a pair of contradictory class names in the latent space using the text encoder, obtaining the features of the plurality of normal images using the image encoder, partitioning the features of the plurality of normal images, introducing noise to at least some of the partitioned features of the of the plurality of normal images to generate abnormal features, and training the projector operator to project the partitioned features of the plurality of normal images and the abnormal features within the latent space. In an example, the pair of contradictory class names include the first text prompt and the second text prompt. Further, the partitioned features of the plurality of normal images are closer to the first text prompt and the abnormal features are closer to the second text prompt.

According to some embodiments, the method further includes reconstructing the projected partitioned features of the plurality of normal images and the features for abnormal images using a reconstruction model, generating a reconstruction loss and a semantic loss based on the reconstruction and the encodings of the pair of contradictory class names, and re-training the projector operator and the visual-language foundation model to minimize the semantic loss and the reconstruction loss.

According to some embodiments, the reconstruction model is a transformer.

According to some embodiments, the image decoder is trained to learn encodings of a plurality of pseudo class names for a plurality of classes within the latent space.

According to some embodiments, training dataset for the image encoder, the text encoder and the image decoder includes a plurality of images of the plurality of classes in a long-tailed distribution.

According to some embodiments, the image encoder is a deep neural network including a sequence of layers, wherein each layer of the sequence of layers produces image features, and wherein the features of the image are formed by combining image features of different layers.

According to some embodiments, the method further includes determining a dot product between the projection of the feature patch with the first text encoding to produce a first score, determining a dot product between the projection of the feature patch with the second text encoding to produce a second score, and detecting the anomaly in the feature patch based on the first score and the second score.

According to some embodiments, the first text prompt is a semantic name of a class of the image, and the second text prompt is a modification of the first text prompt.

According to some embodiments, the first text prompt is a semantic name of a class of the image, and the second text prompt is a concatenation of a modifier word with the semantic name of the class of the image.

According to some embodiments, the first text prompt is a semantic name of a class of the image learned for generating images of the class of the image with a visual-language foundation model.

According to some embodiments, the method further includes partitioning the image into patches corresponding to the feature patches, reconstructing each of the feature patches of the image as image patches using a reconstruction model, comparing the reconstructed image patches with the corresponding partitions of the feature patches to produce reconstruction scores, and detecting the anomaly based on the reconstruction scores.

According to some embodiments, the method further includes capturing results of comparing the projection of each of the feature patches with the first text encoding and the second text encoding as semantic scores, combining the semantic scores with the corresponding reconstruction scores to produce combined scores, and detecting the anomaly based on the combined scores.

In another embodiment, the present disclosure provides a system for detecting an anomaly in a patch of an image. The system comprises a processor and a memory having instructions stored thereon that cause the processor to collect a first text encoding of a first text prompt in a latent space, collect a second text encoding of a second text prompt in the latent space, encode the image to produce features of the image, partition the features of the image into feature patches, and project each of the feature patches into the latent space using a projector operator. In an example, the projector operator is trained to project normal feature patches of normal images closer to the first text encoding than to the second text encoding while projecting noisy feature patches of the normal images closer to the second text encoding than to the first text encoding. The instructions further cause the processor to compare the projection of each of the feature patches with the first text encoding and the second text encoding to detect the anomaly when the projection of a feature patch from the feature patches is closer to the second text encoding than to the first text encoding.

In yet another embodiment, the present disclosure provides a non-transitory computer readable storage medium embodied thereon a program executable by a processor for performing a method. The method includes collecting a first text encoding of a first text prompt in a latent space, collecting a second text encoding of a second text prompt in the latent space, encoding the image to produce features of the image, partitioning the features of the image into feature patches, and projecting each of the feature patches into the latent space using a projector operator. The projector operator is trained to project normal feature patches of normal images closer to the first text encoding than to the second text encoding while projecting noisy feature patches of the normal images closer to the second text encoding than to the first text encoding. The method further includes comparing the projection of each of the feature patches with the first text encoding and the second text encoding to detect the anomaly when the projection of a feature patch from the feature patches is closer to the second text encoding than to the first text encoding.

Further features and advantages will become more readily apparent from the following detailed description when taken in conjunction with the accompanying drawings.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 shows a schematic diagram depicting anomaly detection in an image using a system for anomaly detection, according to some embodiments of the present disclosure.

FIG. 2 shows a block diagram of the system for anomaly detection, according to some embodiments of the present disclosure.

FIG. 3 shows a graphical representation depicting encodings of a pair of contradictory classifiers in a latent space, according to some example embodiments of the present disclosure.

FIG. 4 shows a schematic diagram depicting a first phase of training of the system for anomaly detection, according to some example embodiments of the present disclosure.

FIG. 5 shows a schematic diagram depicting a second phase of training of the system for anomaly detection, according to some example embodiments of the present disclosure.

FIG. 6 shows a schematic diagram depicting the second phase of training of the system for anomaly detection based on losses, according to some example embodiments of the present disclosure.

FIG. 7 shows a flowchart of a method for training the system for anomaly detection, according to some other example embodiments of the present disclosure.

FIG. 8 shows a block diagram depicting detection of an anomaly in an image by the system, according to some example embodiments.

FIG. 9 shows a flowchart of a method for detecting an anomaly in an image, according to some example embodiments of the present disclosure.

FIG. 10 illustrates a use case implementation of the system, according to some example embodiments of the present disclosure.

FIG. 11 illustrates a use case implementation of the system, according to some other example embodiments of the present disclosure.

FIG. 12 shows an overall block diagram of the system, according to some example embodiments of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

### Overview

Anomaly detection refers to the identification of patterns or instances that deviate from the norm or expected behavior within a given dataset. The primary goal of anomaly detection is to recognize data points that exhibit unusual characteristics, potentially indicating errors, defects, or abnormal conditions. Anomaly detection plays a crucial role in various industries and applications, helping to identify outliers, irregularities, or unexpected events that may have significant implications.

Embodiments of the present disclosure are based on a recognition that anomaly detection is complex and challenging in manufacturing environments where a large number of object classes are manufactured and distribution of objects across different classes is highly skewed. Some embodiments are also based on a realization that anomaly detection in manufacturing environment may help to detect, prevent, or analyze machinery failure. Some applications of anomaly detection in manufacturing environments may include, but are not limited to, detecting defects in products, identifying equipment failures, and identifying process deviations that might lead to problems.

Unsupervised anomaly detection (AD) methods aim to identify defective images and localize the defects without observing any defect images during training. These AD methods may be divided into three categories.

The first category includes methods that use a different model per image class or category. In these methods, AD is performed based on a difference in predictions between a pre-trained encoder and a target encoder that is trained to match the predictions of the pre-trained encoder. In certain cases, the method may fit a Gaussian distribution to feature vectors of normal images and use out-of-distribution criteria to perform AD. In certain other cases, reconstruction techniques may be used to train models to reconstruct normal samples and use reconstruction error for AD. However, use of one model per category is costly, has scalability issues and model overhead, and provides limited anomaly generalization and failure or difficulty in identifying global anomalies.

Further, the second category includes methods that improve reconstruction-based models by using a neighborhood attention mask to avoid information leak by using a large visual-language foundation model to provide explanations for defective regions. While leveraging the visual-language foundation models, these methods do not use any class name to detect anomalies. Reconstruction-based models, particularly those that operate in an unsupervised manner without the use of class names, face several challenges. The reconstruction-based models, especially simpler architectures like autoencoders, may fail to capture highly complex patterns present in training data. In real-world scenarios, anomalies may include a mix of rare events and variations within normal data. Reconstruction-based models without class information may fail to distinguish between these cases, leading to false positives or overlooking subtle anomalies. As a result, anomalies that deviate significantly from normal patterns or anomalies with patterns substantially different from the training dataset may not be accurately reconstructed, leading to detection failures. Moreover, as the reconstruction-based models are trained on normal instances, class-agnostic reconstruction-based models may lack the ability to generalize well to new types of anomalies. Further, class imbalance in training data may pose a challenge during training, as the reconstruction-based model may prioritize learning the majority classes, resulting in suboptimal anomaly detection performance for minority classes.

The third category includes methods that use a single model for all classes but require class names to compute an anomaly score. These methods may compute the anomaly score by measuring similarity between text feature vectors for several predefined normal and abnormal text prompts and an input image. In certain cases, auxiliary or specialized training data may be used to train and test the models. While incorporating class information during the training of the model may provide valuable context, it introduces complexities due to, for example, class imbalance, subjectivity in class definitions, labelling challenges, failure to adapt to dynamic and evolving anomalies, overlap between classes, limited generalization to unknown classes, and dependency on class definition.

Embodiments of the present disclosure are based on a recognition that previously discussed anomaly detection methods assume balanced datasets for training, where a number of samples is relatively balanced across different classes. However, this is an unlikely setting for real-world applications where different objects tend to have different popularity.

Accordingly, the present disclosure provides an LTAD method that uses a single model for anomaly detection across multiple object classes. The LTAD method also addresses the challenge of imbalanced training set, and absent class names. For example, the LTAD method combines AD by reconstruction techniques and semantic techniques to perform multi-class AD. The LTAD method overcomes challenges owing to ambiguous class names by learning class names consistent with a semantic space of a visual-language foundation model. Further, the present disclosure provides a training strategy for training the single model of the LTAD method (also referred to hereinafter as LTAD-based model) that uses a data-augmentation procedure to address the data scarcity of long-tailed data and learns class names. Subsequently, the LTAD-based model performs accurate anomaly detection, especially for long-tailed AD. Moreover, the LTAD method generalizes the LTAD-based model across various datasets and imbalance configurations to generate accurate and reliable output for anomaly detection.

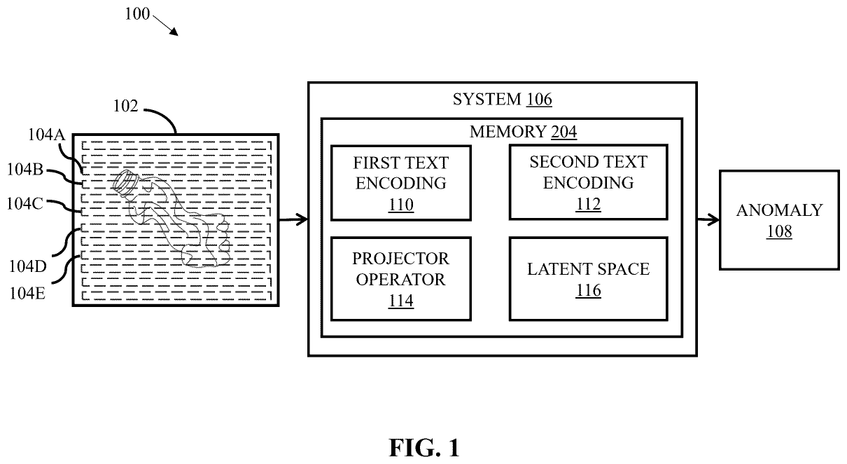

FIG. 1 shows a schematic diagram 100 depicting anomaly detection in an image 102 using a system 106 for anomaly detection, according to some embodiments of the present disclosure. In an example embodiment, the image 102 may correspond to an object depicted as a bottle. However, such depiction of the object should not be construed as a limitation. For example, the image 102 may relate to other objects, such as a machinery, a food item, a packaging item, a clothing item, a chemical formulation, and so forth. In another example, the image 102 may relate to a human, such as an indication of an activity performed by the human. The image 102 may be obtained from an image capturing device, e.g., a video camera (not shown in FIG. 1).

In an example, the system 106 may receive a plurality of images that may include different objects of same object class, different objects of different object class, or different human poses of a same person or different persons. Further, in manufacturing, sample distribution, i.e., a number of images across different object classes, is skewed. In other words, different objects can have very different popularity. This leads to a problem of long-tailed AD due to long-tailed datasets.

Typically, reconstruction-based models may have to perform modeling of complex manifold, especially for problems requiring many classes, and may fail to generate accurate output for anomaly detection. Moreover, semantic-based models may use visual-language foundation model for recognizing class names, but these recognized class names may be ambiguous or unknown to the foundation model. For example, an ambiguity may arise due to the fact that a class name “bottle” refers to visually different concepts in a first dataset (where it means “bottle bottom”) and a second dataset (where it means “bottle side”). Hence, in the first dataset, the “bottle” label may not be accurately informative for the foundation model, which may associate the images with alternative labels, e.g. “black sphere.” Sometimes, class names may be simply unknown to the foundation model.

Some embodiments of the present disclosure are based on a realization that the visual-language foundation model should learn class names that best align with images in training dataset.

A visual-language foundation model (referred to as foundation model hereinafter) refers to a type of artificial intelligence model that is capable of understanding and processing both visual and textual information. The visual-language foundation model integrates computer vision capabilities for interpreting images and natural language processing (NLP) capabilities for understanding textual information. The foundation models are designed to bridge the gap between visual information and language information, enabling a more comprehensive understanding of multimodal data.

In an example, the visual-language foundation model may be pre-trained on large datasets that contain paired images and text, allowing them to learn representations that capture interactions between visual and linguistic elements. Subsequently, the pretrained visual-language foundation models may be fine-tuned for specific downstream tasks. In the context of anomaly detection, the visual-language foundation models may be used to enhance the capabilities of anomaly detection methods. For example, the pretraining process of the visual-language foundation models enables them to learn semantic representations. These semantic representations capture high-level features and relationships within data, making them effective for discerning anomalies that may exhibit nuanced patterns. To this end, the visual-language foundation models may capture contextual information, understanding the relationships between objects in images and the corresponding textual descriptions.

To address the challenges above, the present disclosure discloses the system 106 that performs LTAD. The system 106 combines AD by reconstruction and semantic techniques. The LTAD system 106 is configured to detect an anomaly 108 in a patch of the image 102.

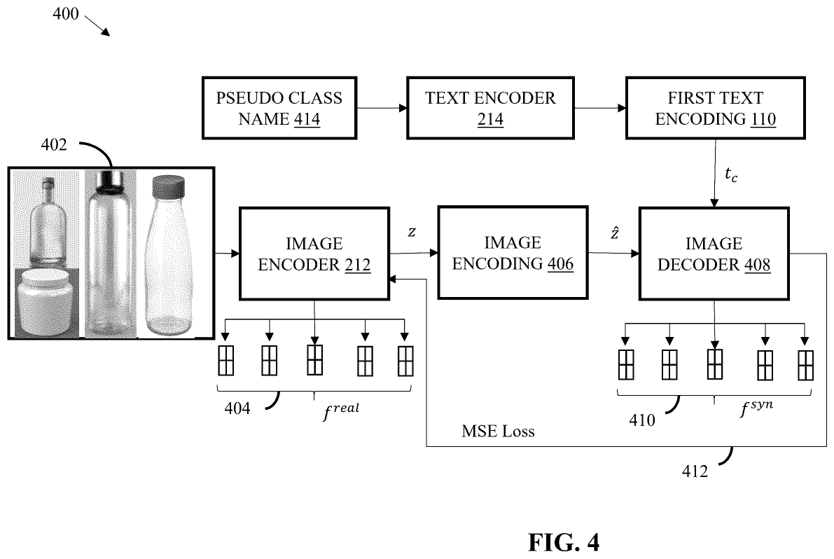

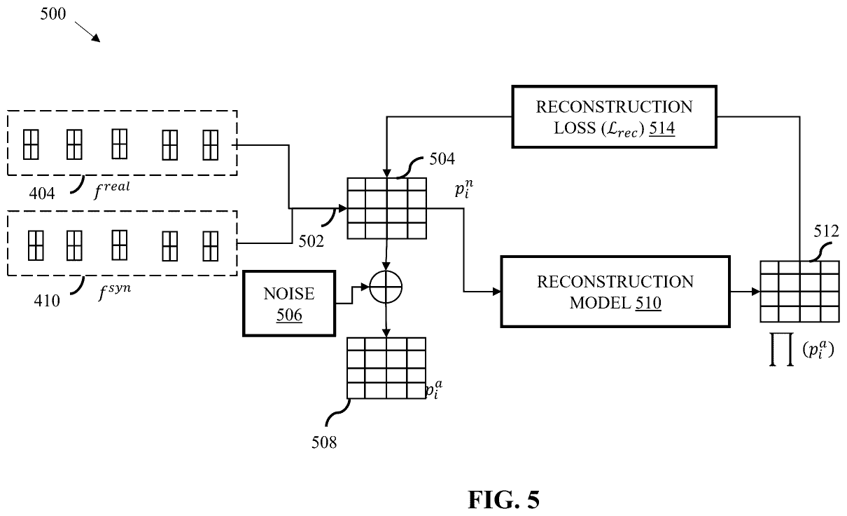

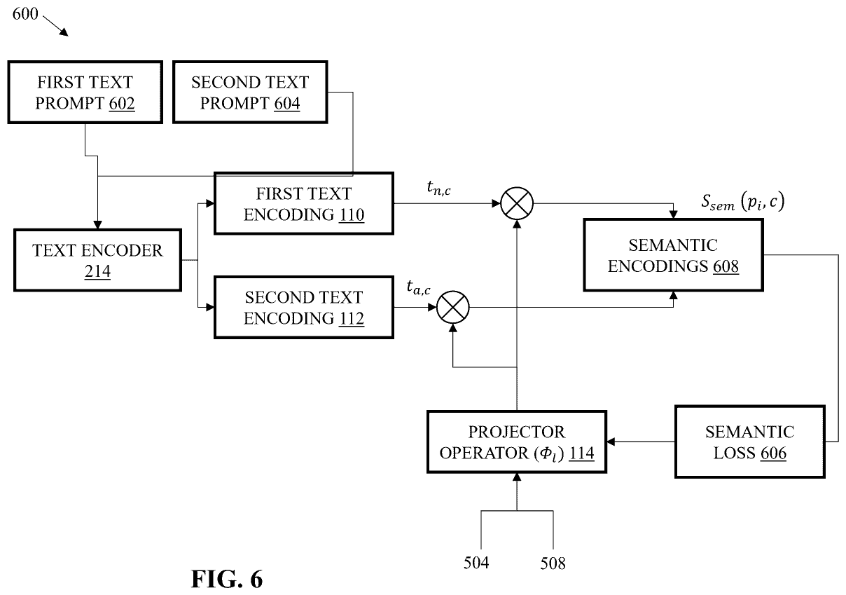

In operation, the system 106 is configured to collect a first text encoding 110 of a first text prompt in a latent space 116 and a second text encoding 112 of a second text prompt in the latent space 116. In an example, the first text prompt and the second text prompt are class names that are learnt by a text encoder of the visual-language foundation model during a training phase. In particular, the text encoder of the visual-language foundation model is configured to process and encode textual information into a numerical representation that is projected in the latent space 116. Particularly, the first text prompt and the second text prompt are contradictory class names. In an example, if the first text prompt is “bottle”, then the second text prompt is “broken bottle” or “deformed bottle”. A manner in which these class names, i.e., text encodings of the text prompts, are learnt by the system 106 is described in conjunction with FIG. 4, FIG. 5, and FIG. 6.

Further, the system 106 is configured to encode the image 102 to produce features of the image 102. In an example, in a multimodal visual-language foundation model, the text encoder works alongside a visual or image encoder to handle both textual and visual inputs. To this end, the image encoder is configured to encode the image 102 to extract features. In an example, the image encoder takes image data of the image 102 as input. This could be in the form of raw pixel values or feature maps generated by a pre-trained convolutional neural network (CNN). For example, the image encoder may perform hierarchical feature extraction from the raw pixel values of the image 102. To this end, the image encoder of the visual-language foundation model may extract relevant features from the image 102.

Furthermore, the system 106 is configured to partition the features of the image 102 into feature patches (depicted as feature patches —104A, 104B, 104C, 104D and 104E and collectively referred to as feature patches 104). In an example, the feature patches 104 are generated by dividing the extracted features of the image 102 into meaningful segments or regions. The partitioning of features based on region into strips of feature patches 104A, 104B, 104C, 104D and 104E is only exemplary and should not be construed as a limitation. In other examples, the extracted features of the image 102 may be partitioned to generate feature patches using, for example, grid-based partitioning, object-based partitioning, semantic partitioning, pixel-based partitioning, interest point-based partitioning, region-based partitioning, and texture-based partitioning.

Thereafter, the system 106 is configured to project each of the feature patches 104 into the latent space 116 using a projector operator 114. In an example, the projector operator 114 is an AI model configured to create a joint multimodal representation with the text encoder in the latent space 116. The joint multimodal representation captures the relationships between visual elements, i.e., the feature patches 104 of the image 102 and textual elements, i.e., the first text encoding 110 and the second text encoding 112. In this manner, anomaly detection is performed in a multimodal context.

In particular, the projector operator 114 is trained to project normal feature patches of normal images closer to the first text encoding 110 than to the second text encoding 112. It may be noted that the first text encoding 110 is a representation of the first text prompt for “normal” features of an object class. Subsequently, the first text prompt indicates a class name that corresponds to a normal class. On the contrary, the second text encoding 112 is a representation of the second text prompt for “abnormal” or “anomalous” features of an object class. Subsequently, the second text prompt indicates a class name that corresponds to an abnormal or anomalous class.

For example, the feature patches 104A and 104B may correspond to normal features of the image 102. In other words, features of an object, i.e., bottle, within regions corresponding to the feature patches 104A and 104B don't have any anomaly or defect. As a result, the features patches 104A and 104B are projected closer to the first text encoding 110 of the first text prompt than the second text encoding 112. Further, the feature patches 104C, 104D and 104E may correspond to anomalous or noisy features of the image 102. The features of an object, i.e., bottle, within regions corresponding to the feature patches 104C, 104D and 104E have one or more anomaly or defects. As a result, the noisy features patches 104C, 104D and 104E of the image 102 are projected closer to the second text encoding 112 of the second text prompt than the first text encoding 110.

It may be noted, the first text prompt of the normal class represents a category of instances or data points that are considered standard, typical, or expected. The normal class represents a majority of instances that conform to a standard behavior or pattern. Alternatively, the second text prompt or the abnormal or anomalous class comprises instances that deviate from the standard behavior or pattern observed in the first text prompt or the normal class. Anomalies are typically rare events, outliers, or instances that exhibit unusual characteristics. As a result, the first text prompt and the second text prompt are referred to as contradictory class names.

Thereafter, the system 106 is configured to compare the projection of each of the feature patches 104 with the first text encoding 110 and the second text encoding 112 to detect the anomaly 108. In particular, the projection of a feature patch, such as the feature patches 104C, 104D and 104E from the feature patches 104 are closer to the second text encoding 112 than to the first text encoding 110. As the second text encoding 112 corresponds to the second text prompt, i.e., “abnormal class name. Subsequently, anomaly detection is performed by identifying one or more feature patches that are closer to the second text encoding 112 than the first text encoding 110. Pursuant to the present example, the feature patches 104C, 104D and 104E are proximal to the second text encoding 112 in the latent space 116, therefore, the feature patches 104C, 104D and 104E are identified as anomalous.

In an example, the identified anomalous feature patches 104C, 104D and 104E may be used to initiate performance of some downstream tasks. Examples of the downstream tasks may include, but are not limited to, an action of stopping an operation of product production, a trigger to stop a machine, an assessment of cause of the anomaly, an assessment of a type of anomaly, recommendation of corrective action, and generating a warning.

In certain cases, all feature patches of an image of an object, such as the bottle, may be closer to the first text encoding 110 or normal class name for representing normal features of the object or the bottle. In such a case, the image 102 may be identified as normal or anomaly-free. In such a case, the system 106 may proceed to perform anomaly detection on another image corresponding to another object belonging to the same class, another view of the same object, or another object belonging to a different class.

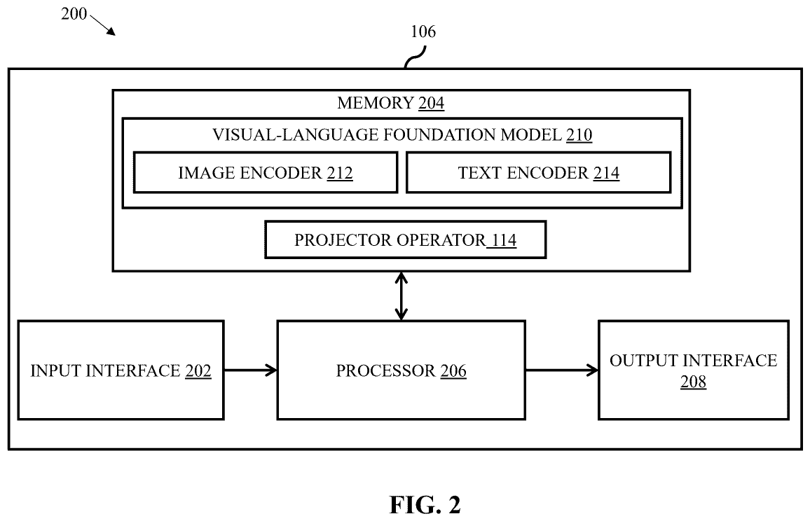

FIG. 2 shows a block diagram 200 of the system 106 for anomaly detection, according to some embodiments of the present disclosure. The system 106 includes an input interface 202, a memory 204, a processor 206, and an output interface 208. The input interface 202 is configured to accept input data. The input data may include an image, a video, or a sequence of images, e.g., the image 102 of FIG. 1.

The memory 204 is configured to store a visual-language foundation model 210, and the projector operator 114. The visual-language foundation model 210 (referred to as model 210, hereinafter) includes an image encoder 212 and a text encoder 214. The image encoder 212 and the text encoder 214 are configured to extract meaningful representations from visual data (such as, the image 102) and textual data (such as, the first text prompt and the second text prompt), respectively. The use of both the image encoder 212 and the text encoder 214 enables the model 210 to understand multimodal information, combining insights from both images and text. The image encoder 212 processes visual information, typically in the form of images, and extracts relevant features. Further, the text encoder 214 processes textual information, i.e., text prompts corresponding to different class names, and converts it into a numerical representation capturing semantic content.

In an example, the image encoder 212 is trained to encode global features of the image 102 into the latent space 116. The latent space 116 is shared by the image encoder 212 and the text encoder 214 of the model 210. To this end, the model 210 combines the representations from the image encoder 212 and the text encoder 214 to create a joint or multimodal representation, referred to as the latent space 116. In this manner, the model 210 captures interactions between modalities. The joint representation or the latent space 116 captures the interactions and relationships between visual and textual elements, allowing the model 210 to understand how images and text complement each other. By combining image and text information, the model 210 gains a more comprehensive understanding of the input data or the image 102. In certain cases, the image encoder 212 is trained to encode feature patches 104 of the global features of the image 102 into the latent space 116. For example, the feature patches 104 may be partitioned global features of the image 102. The image encoder 212 is configured to encode and project the feature patches 104 in the latent space 116 in which the text encoder 214 has encoded and projected the first text encoding 110 and the second text encoding 112.

The processor 206 is configured to collect the first text encoding 110 of the first text prompt and the second text encoding 112 of the second text prompt in the latent space 116. The processor 206 may collect the first text encoding 110 and the second text encoding 112 from the text encoder 214. Further, the processor 206 is configured to encode the image 102 to produce features of the image 102 using the image encoder 212. In addition, the processor 206 is configured to partition the features of the image 102 into the feature patches 104.

The latent space 116 corresponds to a joint representation of visual and textual features generated by the image encoder 212 and the text encoder 214. This enables the implementation of semantic anomaly detection. In this regard, the first text prompt and the second text prompt are encoded in the latent space 116 as the first text encoding 110 and the second text encoding 112, respectively. The first text encoding 110 and the second text encoding 112 may be classifier weight vectors forming representations for normal and abnormal text prompts in the latent space 116.

Further, using the image encoder 212 of the visual-language foundation model 210 and the projector operator 114, the processor 206 is configured to project each of the feature patches 104 into the latent space 116. For example, the projector operator 114 is configured to project abnormal or anomalous feature patches, such as the feature patches 104C, 104D and 104E closer to the second text encoding 112 than the first text encoding 110. On the other hand, the projector operator 114 is configured to project normal feature patches, such as the feature patches 104A and 104B closer to the first text encoding 110 than the second text encoding 112.

Further, the processor 206 is configured to detect an anomaly in the feature patches 104 based on their projection in the latent space 116. In particular, the processor 206 may compare whether a feature patch is closer to the second text encoding 112 or the first text encoding 110 in the latent space. In this regard, the processor is configured to determine a dot product between a projection of a feature patch, say the feature patch 104A, with the first text encoding 110 to produce a first score. Thereafter, the processor 206 is configured to determine a dot product between the projection of the feature patch 104A with the second text encoding 112 to produce a second score. Based on a comparison between the first score and the second score for the feature patch 104A, a determination is made whether the feature patch 104A is anomalous or normal. For example, if the first score, i.e., a distance of the feature patch 104A from the first text encoding 110, is greater than the second score, i.e., a distance of the feature patch 104A from the second text encoding 112, then the feature patch 104A is determined as anomalous. For example, the first score being greater than the second score may indicate that the feature patch 104A is tending towards the second or abnormal text prompt, thereby identifying the feature patch 104A as anomalous. Alternatively, if the first score is smaller than the second score, then it may indicate that the feature patch 104A is tending towards the first or normal text prompt, thereby identifying the feature patch 104A as normal.

In an example, the processor 206 is configured to generate an anomaly score for the image 102 based on a difference between the input image 102 and the result of the projections of each of the feature patches 104 of the image 102. The anomaly score may indicate or quantify a level of anomalous behavior of the image 102. In this manner, an extent of anomaly in the object or the bottle associated with the image 102 is determined.

Further, the processor 206 is configured to generate the anomaly score for the image 102 based on the identified anomalous feature patches form the feature patches 104. The anomaly score and/or the identified anomalous feature patches may be provided to the output interface 208 to render the anomaly 108 or an anomaly detection result. The anomaly detection result may correspond to detection of an anomaly and localization of the detected anomaly in the image 102. In some example embodiments, the processor 206 is further configured to output a notification, based on the detected anomaly 108. The notification may be provided to the human via the output interface 208.

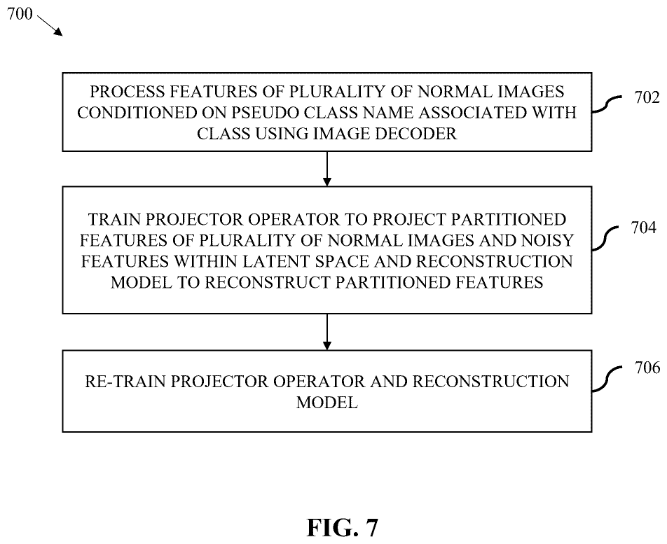

In some embodiments, to address the long-tailed setting, a preliminary training phase is performed for data augmentation. The pre-liminary training phase comprises learning an auto-encoder or a variational auto-encoder (VAE), which is then used to synthesize features for class names. To make the class names sensitive, the VAE is conditioned by a text encoding of a class name, according to the model 210. Further, to address ambiguity of class names, a set of learnable class prompts are learned by backpropagation during the training of the VAE. In a second training phase, a mix of real and synthetic examples are used to train the projector operator 114. Details of the training of the projector operator 114 are described in conjunction with FIG. 4, FIG. 5, FIG. 6, and FIG. 7.

According to some embodiments, the system 106 performs anomaly detection using reconstruction method as well as semantic method. The anomaly detection by reconstruction method is implemented by combining the image encoder 212 and the projector operator 114 that is trained to project the feature patches 104 into the latent space 116. The latent space 116 includes a manifold of normal images, based on the training.

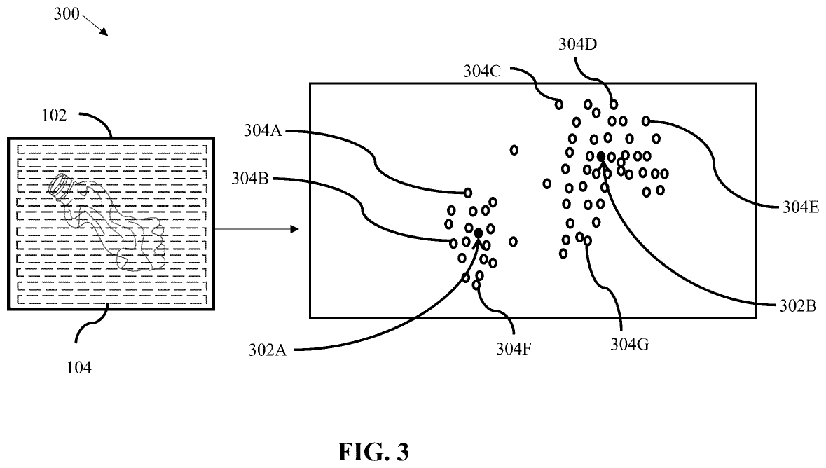

FIG. 3 shows a graphical representation 300 depicting encodings of a pair of contradictory classifiers in the latent space 116, according to some example embodiments of the present disclosure.

The latent space 116 includes projections or encodings of text prompts or class names. For example, the latent space 116 may include projections of a plurality of pairs of contradictory classes. A pair of contradictory classes may include, for example, the first text prompt as a normal classifier and the second text prompt as an abnormal classifier for an object class of “bottle”. In a similar manner, different pairs of contradictory classes may correspond to normal and abnormal classifiers of different object classes. The projections of the plurality of pairs of contradictory classes in the latent space 116 are learnt during the training. In addition, during the training, a manifold of normal images for the different object classes may also be created in the latent space 116.

Further, during the inference, the feature patches 104 of the image 102 are projected into the latent space 116. For example, the projector operator 114 is trained to compute projections of each of the feature patches 104 into the latent space 116 of the model 210, where classifier parameters of the text prompts, such as the first text prompt and the second text prompt are defined.

Pursuant to the present example, a projection of the first text prompt in the latent space 116 is depicted as a first text prompt projection 302A and a projection of the second text prompt in the latent space 116 is depicted as a second text prompt projection 302B. Moreover, projections of the feature patches 104 are depicted as feature projections 304A, 304B, 304C, 304D, and 304E. In an example, the feature projection 304A corresponds to the feature patch 104A, feature projection 304B corresponds to the feature patch 104B, feature projection 304C corresponds to the feature patch 104C, feature projection 304D corresponds to the feature patch 104D, and feature projection 304E corresponds to the feature patch 104E.

The projector operator 114 is trained to project the feature patches 104 as the feature projections 304A, 304B, 304C, 304D, and 304E into the latent space 116 where the text prompts are projected. For example, as the feature patches 104A and 104B correspond to region of the image 102 that does not have any anomaly, the feature projections 304A and 304B are projected closer to the first text prompt projection 302A than the second text prompt projection 302B. On the other hand, as the feature patches 104C, 104D and 104E correspond to region of the image 102 that includes anomaly or defect, the feature projections 304C, 304D and 304E are projected closer to the second text prompt projection 302B than the first text prompt projection 302A.

To determine if a feature patch, say the feature patch 104A, is anomalous or not, a first score of the feature patch 104A is compared with a second score of the feature patch 104A. In this regard, the first score is determined based on a dot product of the projection 304A of the feature patch 104A and the first text prompt projection 302A; and the second score is determined based on a dot product of the projection 304A and the second text prompt projection 302B. Based on the first score and the second score, the feature patch 104 is determined to be anomalous or normal.

### Overview of Training

FIG. 4 shows a schematic diagram 400 depicting a first phase of training of the system 106 for anomaly detection, according to some other example embodiments of the present disclosure. Pursuant to the present disclosure, the training of the system 106 is performed into two phases.

In particular, the first phase of the training corresponds to class sensitive data augmentation. An objective of the first phase of the training is to overcome data scarcity in a long-tailed training dataset 402 by augmenting the training dataset 402 with normal examples of minority classes and abnormal examples of all classes. Another objective of the first phase of the training is to learn the class sensitive text prompts, s_{c} required by sematic method for anomaly detection.

In an example, the processor 206 is configured to collect a plurality of normal images associated with a class, c, and store it as the training dataset 402. In certain cases, the training dataset 402 may include plurality of normal images corresponding to plurality of different classes. The processor 206 is configured to encode the plurality of normal images to produce features of the plurality of normal images using the image encoder 212. In an example, for a normal image, I∈R^{W×H×3}, of class, c ∈C, from the training dataset 402, the pre-trained image encoder 212, E, extracts features as feature tensors. The features are extracted as a feature tensor, f^{real} and a latent code, z.

In an example, the image encoder 212 is a deep neural network including a sequence of layers. Further, each layer of the sequence of layers produces image features. Moreover, features of the normal image under consideration are formed by combining image features 404 of different layers. In an example, the image encoder 212 may have L number of layers. The feature tensor and the latent code may be defined as:

$$\begin{matrix}{f}^{real} = [ {f}_{1}^{real} , {f}_{2}^{real} , … , {f}_{L - 1}^{real} , and \\ z = {f}_{L}^{real}\end{matrix}$$

In this regard, the latent code, z, is a feature vector from a last layer (L) of the image encoder 212. The feature tensor and the latent code are used by the image encoder 212 to generate an image encoding 406 or the features of the normal image from the training dataset 402 based on features generated by each of the layers from the sequence of layers. The image encoding 406 may indicate the features of the normal image. In particular, the image encoder 212 is pre-trained and its weights are frozen. During the training phase, the image encoder 212 may generate the image encoding 406 of the normal image by combining the image features 404 of different layers.

Further, the first phase of the training includes training an image decoder 408, D. In an example, the image decoder 408 is a VAE-style decoder. The image decoder 408 is learnt or trained for feature augmentation of image features conditioned on different pseudo class names, such as a pseudo class name 414. For example, an architecture of the image decoder 408 is same as an architecture of the image encoder 212.

The processor 206 is configured to process the features of the plurality of normal images conditioned on the pseudo class name 414 using the image decoder 408. The image decoder 408 is trained to sample feature vectors of the normal image, based on the operations of VAE. In an example, a latent feature, \hat{z}, of the normal image is sampled from a normal distribution N(μ, σ) of parameters μ=Fμ(z) and σ=Fσ(z), where Fμ and Fσ are learned linear transformations. For example, the pseudo class name 414 is the first text prompt. The pseudo class name 414 is provided to the text encoder 214. In this case, the text encoder 214 generates the first text encoding 110 in the latent space 116 based on the pre-training of the foundation model 210. In such a case, the features of the normal image are processed by conditioning the features on the first text prompt, i.e., the normal classifier. In this manner, a manifold of normal images corresponding to the first text prompt is generated in the latent space 116.

The processor 206 is further configured to train the image decoder 408 to learn the pseudo class name 414 as the first text encoding 110. In this regard, the image decoder 408 is configured to synthesize the feature tensor using the latent feature, \hat{z}. In particular, a sequence of layers of the image decoder 408 are configured to generate image features 410 that are combined to generate the synthesized features for the normal image. The first text encoding 110, represented as t_{c}, and the real features generated by the image encoder 212 are fed to the image decoder 408 to generate the synthesized features. The synthesized features are provided as feedback 412 to the image encoder 212. In particular, the synthesized features generated by the image decoder 408 and the real features generated by the image encoder 212 are compared to generate MSE losses and re-train the image decoder 408.

In the long-tailed dataset, a performance of the image decoder 408 degrades for classes with few training images in the training dataset 402. Specifically, the training dataset 402 for the image encoder 212, the text encoder 214 and the image decoder 408 includes a plurality of images of a plurality of classes in a long-tailed distribution. In other words, the plurality of images may include varying number of images belonging to the different classes, such that some classes may form majority due to having a large number of images associated with those classes, while others may form minority due to having a very small number of images associated with these classes.

To ameliorate this problem, the image decoder 408 is trained to have the prior knowledge about the class names, in the form of a text-derived prototype feature, i.e., the first text encoding, t_{c}, 110. The first text encoding 110 represents a class, c, for feature synthesis of the class. The first text encoding 110 may be obtained by prompting the text encoder 214 of the model 210 with the pseudo-class name s_{c}, i.e., t_{c}=T(s_{c}). The first text encoding 110 is then concatenated with the image-dependent latent feature, \hat{z}, to create or recreate the input to the image decoder 408. Based on the input to the image decoder 408, a feature tensor, {fₗ^{syn}},ₗ₌₁^{L}=D(\hat{z}, t_{c}) is synthesized having dimensions equal to that of f^{real} Following standard practices for VAE training, the image decoder 408 and the pseudo class name 414, s_{c}, are learned by optimizing a loss function. The loss function is defined as:

$${ℒ}_{ℙ 1} = \frac{1}{L - 1} {\sum }_{l = 1}^{L - 1} {‖ {f}_{l}^{syn} - {f}_{l}^{real} ‖}^{2} - K L ( N ( \hat{z} - μ , σ ) ‖ N ( 0 , I ) ) \qquad ( 1 )$$

For example, the loss function is a combination of a mean square error (MSE) loss and a KL-Divergence loss to enforce the normal distribution of the latent space 116. The MSE loss is between the features, fₗ^{real}, extracted by the image encoder 212 and the features, fₗ^{syn}, synthesized by the image decoder 408. The text encoder 214 and the image encoder 212 are associated with the pretrained foundation model 210 and kept frozen throughout training. This aims to enable learning of the image decoder 408 that can be used to synthesize features from tail classes, i.e., classes having very few number of images in the training dataset 402. In addition, by keeping the text encoder 214 and the image encoder 212 frozen, the features of the training images are aligned with the semantic representation t_{c} produced by the text encoder 214 of the model 210. Moreover, a quality of feature synthesis for tail classes, by leveraging this alignment is improved. In this manner, the image decoder 408 is trained to learn the first text encoding 110 corresponding to the pseudo class name in the latent space 116. Subsequently, the image decoder 408 is trained to learn encodings of a plurality of pseudo class names for a plurality of classes within the latent space 116. After training, the learned prompts, such as the first text prompt, se are used in a second training phase and the inference phase.

In an example, the first phase training is performed for 100 epochs using an Adam optimizer with a learning rate 1e-4. Further, to train the projector operator 114 in the second phase of the training, the pretrained visual-language foundation model 210 is used. In this regard, each input image from the training dataset 402 is scaled to 224×224 pixels and the image features 404, f^{real}, are extracted from the sequence of layers of the image encoder 212 of the model 210. In an example, a default length of the pseudo class name 414 is set to 2 and initialized with a text “object-object.”

FIG. 5 shows a schematic diagram 500 depicting a second phase of training of the system 106 for anomaly detection, according to some other example embodiments of the present disclosure. When the first training phase is completed, the image decoder 408 works as a data augmentation device to produce synthetic feature tensors, f^{syn}, or image features 410 in a semantic neighborhood of a feature tensor, f^{real}, or image features 404 extracted from a real image from the training dataset 402. This is used to augment the training dataset 402 in an online manner during the second phase of the training.

Pursuant to embodiments of the present disclosure, two types of data augmentation, such as long-tailed classes augmentation and anomalies augmentation, are performed. In order to counteract an imbalanced nature of long-tailed training dataset, data augmentation is implemented by selecting real image features 404 or synthesized image features 410 with probabilities p_{c} or 1−p_{c}, respectively. For example, the image features 404 and 410 are layer-wise features. These layer-wise features are aggregated or concatenated 502 to produce a single patch feature vector, such as normal patch features 504 for the normal image. To counteract the lack of anomalies during training, random noise 506 (sampled from a normal distribution) is added to the normal patch features 504 to produce pseudo-anomaly patch features 508. This process is repeated for all normal patches during training. No random noise is added during inference.

In an example, the probability p_{c} of selecting real image features 404 is 0.5. A hyperparameter λ is set to 500, 400, and 300 for different training datasets, for example, MVtec, VisA, and DAGM, respectively. It may be noted that use of images from the MVtec, VisA, and DAGM datasets to form the training dataset 402 is only exemplary. In certain cases, other dataset(s) may be used. In certain other cases, the training dataset 402 may be generated.

In an example, a feature vector, f, corresponding to the normal image from the training dataset 402 is split into W₁×H₁ patch feature vectors, i.e., patches of width W₁. and height H₁. For example, global features of the normal image are partitioned into patches, such that a summation of features of the patches or normal patch feature vectors is defined as normal patch features 504, {pᵢⁿ}ᵢ₌₁^{W}^{₁}^{×H}^{₁}. Herein the ‘n’ superscript denotes that these are normal features or normal feature vectors.

Further, data augmentation by anomaly is performed to counteract a lack of anomalies-related images during training, i.e., lack of abnormal or anomalous images in the training dataset 402. In this regard, the random noise 506 is added to the normal patch features, pᵢⁿ, 504 to produce the pseudo-anomaly patch features 508.

Further, data augmentation is used in the second phase of training to learn parameters of a reconstruction model (RM) 510. In an example, the reconstruction model 510 is implemented as a transformer, such as a RM transformer, Π(.). Moreover, the RM transformer is configured to reconstruct features of an image from its projection in the latent space 116. Further, data augmentation is used in the second phase of the training to learn or train the projector operator, Φₗ(.), 114 to project the image features from patches into the latent space 116 of the model 210. Training of the projector operator 114 based on the data augmentation is described in detail in conjunction with FIG. 6.

In an example, the RM 510 is a type of anomaly detection model that operates on a principle of reconstructing input data, such as image features. During the training, the RM 510 is trained to learn a compressed representation (encoding) of normal image features 404 and then use it to reconstruct input data. Subsequently, anomalies in an image, being different from the learnt normal patterns, result in higher reconstruction errors, making them detectable. Examples of the transformer used as the reconstruction model 510 may include, but are not limited to, bidirectional encoder representations from transformers (BERT), generative predictive text (GPT), and text-to-text transfer transformer (T5).

Pursuant to the embodiments of the present disclosure, the model 210 is trained to project pseudo-anomaly patch features, pᵢ^{a}, 508 into reconstructed patch features, Π(pᵢ^{a}), 512 generated by the RM 510. In an example, the pseudo-anomaly patch features 508 are projected in a manifold of the normal patch features, pᵢⁿ, 504. The projection is implemented with the RM transformer or the RM 510 to minimize a reconstruction loss 514. The reconstruction loss 514 is defined as:

$${ℒ}_{rec} = \frac{1}{{W}_{1} {H}_{1}} {\sum }_{i = 1}^{{W}_{1} {H}_{1}} {‖ \prod ( {p}_{i}^{a} ) - {p}_{i}^{n} ‖}^{2} \qquad ( 2 )$$

FIG. 6 shows another schematic diagram 600 depicting the second phase of the training of the system 106 for anomaly detection based on losses, according to some other example embodiments of the present disclosure. In particular, the second phase of training the system 106 for LTAD training comprises learning the parameters of the RM 510 (as described in FIG. 5) and learning parameters of the projector operator 114. The parameters of the projector operator 114 are used to map visual features of patches into the latent space 116 of a semantic AD (SAD) module or the model 210. For example, the data augmentation is used to train the projector operator, Φₗ(.), 114 for semantic patch projections in the latent space 116 of the model 210.

During the second phase of the training, the processor 206 is configured to obtain encodings of a pair of contradictory class names in the latent space 116 using the text encoder 214. The pair of contradictory class names include a first text prompt 602 and a second text prompt 604. It may be noted classifier parameters or dimensions for class names, such as the first text prompt 602 and the second text prompt 604 are defined in the latent space 116. In an example, the first text prompt 602 is a normal classifier having classifier parameters as: [vⁿ; s_{c}]. Moreover, the second text prompt 604 is an abnormal classifier having classifier parameters as: [V^{a}; s_{c}]. In an example, vⁿ=“a” and v^{a}=“a broken”. Moreover, s_{c} is a semantic class name, for example, bottle, that is learnt during the first phase of the training. The first text prompt 602 and the second text prompt 604 are fed to the text encoder 214. The text encoder 214 is configured to generate the first text encoding 110 and the second text encoding 112 in the latent space 116.

Further, the processor 206 is configured to obtain the features of the plurality of normal images. In particular, the real image features 404 and the synthesized image features 410 of the normal image are obtained from the image encoder 212 and the image decoder 408, respectively. Thereafter, the processor 206 is configured to partition the features of the normal image. Based on the partitioning, the normal patch features 504 are generated for the normal image.

Further, the processor 206 is configured to introduce the random noise 506 to at least some of the partitioned features or the normal patch features 504 of the plurality of normal images to generate abnormal features (referred to as pseudo-anomaly patch features 508).

The processor 206 is configured to train the projector operator 114 to project the partitioned features, i.e., the normal patch features 504, of the plurality of normal images and the abnormal features, i.e., the pseudo-anomaly patch features 508, within the latent space 116. The projector operator 114 is trained to project the normal patch features 504 of the plurality of normal images closer to the first text prompt or the first text encoding 110, and the pseudo-anomaly patch features 508 closer to the second text prompt or second first text encoding 112.

In an example, the projector operator, Φₗ, 114 is trained to compute projections of the patches, pᵢ, into the latent space 116 of the model 210, referred to a semantic encodings 608. In this regard, the projector operator, Φₗ, 114 is trained to encourage alignment between text features and visual or image features by minimizing a binary semantic loss 606. The text features may include text features, t_{n,c}, of the first text encoding 110 and text features, t_{a,c}, of the second text encoding 112. Further, the visual or image features may include the projected patch features of the normal image, such as the normal patch features 504 and the pseudo-anomaly patch features 508.

In an example, the sematic loss 606 is a cross-entropy loss. The sematic loss 606 is defined as:

$${ℒ}_{s e m} ( c ) = \frac{- 1}{{W}_{1} {H}_{1}} {\sum }_{i = 1}^{{W}_{1} {H}_{1}} {y}_{i} log ( {S}_{s e m} ( {p}_{i} , c ) ) , {y}_{i} = \{ \begin{matrix}1 , if {p}_{i} = {p}_{i}^{a} \\ 0 , if {p}_{i} = {p}_{i}^{n}\end{matrix} \qquad ( 3 )$$

Herein, c is an image class of the image, Sₛₑₘ(.) is a semantic score for the image of class c. In both the first phase and the second phase of the training, the text encoder 214 is shared. Moreover, the text encoder 214 is fixed in both the phases. Further, a combined loss function for the second phase is [symbol] = [symbol] + [symbol] (C).

In an example, the second phase training is performed for 500 epochs, using an Adam optimizer with a learning rate 1e-4.

Once the first and the second phase of the training is complete, an average performance of the projector operator 114 is computed for majority (High) classes, minority (Low) classes, and all (All) classes in the training dataset 402. The performance of the projector operator 114 is assessed accordingly. Further, during testing, at least two training examples per class are used as support set to estimate a normal distribution.

The early methods for anomaly detection are not suitable to detect and localize defects across classes with a single model, leading to inferior performance. Further, more recent models may be able to detect defects across classes using a single model. However, they fail to perform well across levels of dataset imbalance. To this end, the system 106 based on LTAD is less affected by skewed distributions and outperforms the conventional anomaly detection methods. Further, it may be noted that detections of anomaly using the LTAD are much more localized and selective of the anomaly.

FIG. 7 shows a flowchart 700 of a method for training the system 106 for anomaly detection, according to some other example embodiments of the present disclosure. The steps of the method are described in conjunction with the elements of the FIG. 4, FIG. 5 and FIG. 6. As described above, the training of the system 106 is performed in two phases.

In particular, a task or a problem of long-tailed AD is introduced by proposing datasets and performance metrics and a novel AD method, LTAD, tailored for the long-tailed setting. The system 106 is based on the LTAD method and is configured to detect defects from multiple and long-tailed classes, without relying on dataset class names. The system 106 combines AD by reconstruction, i.e., by using RM 510, and semantic methods, i.e., by using the foundation model 210. The RM 510 is implemented as a transformer-based reconstruction model, while semantic AD is implemented using a binary classifier that relies on learned pseudo class names and the pretrained model 210. The RM 510 and the model 210 are learned over two phases.

At 702, features of a plurality of normal images are processed conditioned on the pseudo class name 414 associated with the class, c, using the image decoder 408. The plurality of normal images associated with the class is stored in the training dataset 402. In an example, a normal image is first processed by the sequence of layers of the image encoder 212 to generate image features 404. These image features 404 are combined to generate the real image features, f^{real}, for the normal image. The first phase of the training includes learning of the pseudo-class names, such as the pseudo class name 414 corresponding to first text prompt or a normal classifier.

The real image features, f^{real}, along with the first text encoding, t_{c}, 110 of the first text prompt learnt by the text encoder 214 are provided to the image decoder 408. The image decoder 408 processes the real image features, f^{real} conditioned on the pseudo class name 414 or the first text encoding 110 to generate the synthesized image features, f^{syn}. Based on the synthesized image features, the image decoder 408 is trained to perform feature synthesis that augments the training dataset 402 to combat long-tails. Details of the first phase of the training are described in conjunction with, for example, FIG. 4.

At 704, the projector operator 114 is trained to project partitioned features of the plurality of normal images and noisy features within the latent space 116 of the model 210. In particular, the real image features, f^{real}, and the synthesized image features, f_{syn}, are aggregated using layer-wise concatenation 502 to generate the normal patch features 504. Further, noise 506 is added to the normal patch features 504 to generate abnormal or noisy patch features, i.e., the pseudo-anomaly patch features 508. Thereafter, the normal patch features 504 and the pseudo-anomaly patch features 508 are fed to the projector operator 114 for training.

In particular, the second phase of the training includes learning of the parameters of the RM 510 and the projector operator 114 of LTAD. In this regard, the parameters of the projector operator 114 are learned by causing the projector operator 114 to project the normal patch features 504 and the pseudo-anomaly patch features 508 in the latent space 116. The latent space 116 includes the first text encoding 110 and the second text encoding 112 based on encodings generated by the text encoder 214 of the foundation model 210. The projector operator 114 is trained to project the partitioned features of normal images, i.e., the normal patch features 504, closer to the first text encoding 110 than the second text encoding 112. Similarly, the projector operator 114 is trained to project the noisy or abnormal features, i.e., the pseudo-anomaly patch features 508, closer to the second text encoding 112 than the first text encoding 110. The projections of the normal patch features 504 and the pseudo-anomaly patch features 508 in the latent space 116 are semantic encodings 608. Details of the training of the projector operator 114 are described in conjunction with, for example, FIG. 6.

Based on the semantic encodings 608 of the visual features of the normal image in the latent space 116 and the encodings of the pair of contradictory class names, the semantic loss 606 is generated. In an example, the pair of contradictory class names are first text prompt 602 and the second text prompt 604. It may be noted, the first text prompt 602 is the semantic name of the class of the image learned for generating images of the class of the image with the visual-language foundation model 210. In an example, the first text prompt 602 is a semantic name of a class of the normal image, and the second text prompt 604 is a modification of the first text prompt 602. In another example, the first text prompt 602 is the semantic name of the class of the normal image, and the second text prompt 604 is a concatenation of a modifier word with the semantic name of the class of the image. For example, the semantic name of the class of the image is defined as “bottle”. Subsequently, the modifier word may be, for example, “broken”, “defected”, “crushed”, etc.

In an example, the processor 206 is configured to reconstruct the projected partitioned features of the plurality of normal images using the RM 510. In order to learn the parameters of the RM 510 in the second phase, the projected partitioned features, i.e., the normal patch features 504 of a normal image from the plurality of normal images are fed to the RM 510. The RM 510 reconstructs images as the reconstructed patch features 512 based on the normal patch features 504.

Further, the processor is configured to generate the reconstruction loss 514 based on the reconstruction. In this regard, the reconstructed patch features 512 are compared with the normal patch features 504 to generate the reconstruction loss 514. Details of the training of the RM 510 are described in conjunction with, for example, FIG. 5.

At 706, the projector operator 114 and the RM 510 are re-trained to minimize the semantic loss 606 and the reconstruction loss 514. In this regard, the parameters of the projector operator 114 and the RM 510 are updated in order to reduce differences between their predicted outputs and the actual values. These differences are measured by loss functions as the semantic loss 606 and the reconstruction loss 514.

### Overview of Implementation

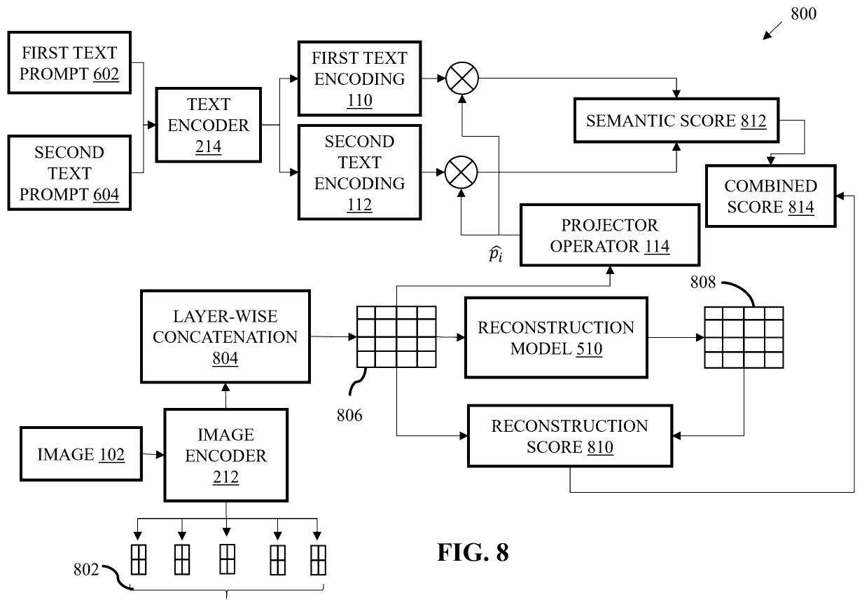

FIG. 8A shows a block diagram 800 depicting detection of the anomaly 108 in the image 102 using the system 106, according to some example embodiments. The system 106 uses an LTAD architecture for anomaly detection. The LTAD architecture is implemented using the projector operation 114 for performing semantic-based anomaly detection and the RM 510 for performing reconstruction-based anomaly detection.

In operation, the pre-trained image encoder 212 of the model 210 receives the image 102. The anomaly detection is to be performed on the image 102. For example, the image 102 may depict an object, such as an item, a person, etc. In particular, the image 102 may depict a specific pose of the object. In order to detect anomaly in the object, a sequence of images or a video of the different poses of the object may be processed to detect and localize any anomaly in any of the sequence of images and thus in the object.

The image encoder 212 includes a sequence of layers. Each layer from the sequence of layers produces image features 802 corresponding to the image 102. Further, features 806 of the image 102 are formed by combining the image features 802 of the different layers. The image features 802 are combined using a layer-wise concatenation 804.

Further, the features 806 of the image 102 is provided to the RM 510 to perform reconstruction-based AD. The RM 510 Π(.) is a transformer trained to reconstruct the features 806 extracted from the image 102, I, to generate reconstructed image patches 808. The reconstructed image patches 808 are generated based on the pre-trained image encoder 212 of L layers. Given the image 102, I∈R^{W×H×3} from class c ∈C, the image encoder 212 extracts feature tensor fₗ^{real} ∈R^{W}^{ₗ}^{×H}^{ₗ}^{×c}^{ₗ} from layer l ∈(1, . . . , L). Since a feature tensor from a last layer f_{L}^{real} represents the global features of the image 102, the last layer feature tensor tends to degrade the AD performance. Since the reconstruction-based anomaly detection requires local semantics or local features, the last layer feature tensor is dropped and the first L−1 feature tensors {fₗ^{real}}ₗ₌₁^{L-1} are remapped to the dimensions of the fₗ^{real}, i.e., W₁×H₁, using bi-linear interpolation along the spatial dimension.

In an example, the processor 206 is configured to generate the features 806 of the image using the image encoder 212. Further, the processor 206 is configured to partition the image 102 or the features 806 into patches corresponding to the feature patches 106. For example, the notation fₗ^{real} is used to represent the interpolated version and define f^{real}=[f₁^{real}, . . . , f_{L-1}^{real}] as the feature tensor extracted across the L−1 layers. In an example, the extracted feature tensors are then split or partitioned into W₁×H₁ feature patches 104, defined as {pᵢ}ᵢ₌₁^{W}^{₁}^{×H}^{₁}.

The processor 206 is configured to reconstruct each of the feature patches 104 of the image 102 using the RM 510 as image patches 808. The feature patches 104 may be vectors that are fed to the RM 510, Π(.), as tokens. Further, the processor 206 is configured to compare the reconstructed image patches 808 with the corresponding partitions of the feature patches 806 to produce reconstruction scores. Given a feature patch, pᵢ, and its corresponding reconstructed image patch Π(pᵢ) generated by the RM 510, a reconstruction score 810 is generated. The reconstruction score 810 is a squared error and is defined as:

$${S}_{rec} ( {p}_{i} ) = {‖ \prod ( {p}_{i} ) - {p}_{i} ‖}^{2} \qquad ( 3 )$$

The processor 206 is configured to detect the anomaly 108 based on the reconstruction score 810. As may be noted from Eq. (3), the reconstruction score is proportional to a square of difference between reconstructed image patch and the generated feature patch. Subsequently, when the reconstructed image patch closely resembles the feature patch, the difference is smaller leading to a small magnitude of reconstruction score. When the reconstruction score is small, then the image 102 may tend towards normal behavior. Alternatively, when the reconstructed image patch varies from the feature patch, the difference is large leading to a large magnitude of reconstruction score. When the reconstruction score is large, then the image 102 may tend towards abnormal behavior.

In the reconstruction-based AD, the RM 510 is trained to reconstruct normal images. During the inference phase, the RM 510 projects abnormal images into the normal image manifold. The anomaly detection may be performed by thresholding a magnitude of the reconstruction error to generate the reconstruction score 810.

Further, the system 106 is configured to perform semantic-based AD. In this regard, a goal of semantic AD is two-fold, i.e., to give the anomaly detector sensitivity to normal/abnormal classes, and to leverage the prior knowledge about normality/abnormality available in the model 210. This allows the AD to discriminate between the two conditions or contradictory classes without requiring abnormal images for training.

In an example, the semantic-based AD is performed using the trained projector operator 114. The projector operator 114 is a binary classifier of a projection, \hat{p}ₗ, of a feature patch, pᵢ. In this regard, the projector operator 114 is configured to receive the features 806 of the of the image 102 generated by the image encoder 212. In particular, the projector operator 114 may receive the features 806 as feature patches 104.

In an example, layer-wise components, pᵢₗ, of the feature patch, pᵢ. Are first projected into vectors. This vectors are denoted as: Φₗ (pᵢₗ). The layer-wise components may be projected into vectors with a dimension, d, of the text embedding, i.e., dimension of the first text encoding 110 and the second text encoding 112 in the latent space 116 of the model 210. In an example, the projection of the layer-wise components into vectors are performed by projector modules of the projector operator 114 as: Φₗ: R^{c}^{ₗ}→R^{d}, l=1, . . . , L−1, where each of the projector modules is implemented with each layer of the image encoder 212. The layer-wise vectors are then aggregated into a single feature patch vector. The feature patch vector is for feature patch is denoted as:

$$\hat{{p}_{ι}} = \begin{matrix}max \\ l\end{matrix} ( {\{ {Φ}_{l} ( {P}_{il} ) \}}_{l} ) \qquad ( 4 )$$

In an example, the layer-wise vectors are aggregated into the feature patch vector by max-pooling over the layers L−1. The resulting vector, \hat{p}ₗ, is fed to the projector operator 114 to project the vector into the latent space 116 having classifier parameters for class names. This projector operator 114 is advantageous because typically the image encoder 212 and text encoder 214 of the foundation model 210 are only aligned in the latent space 116 globally (i.e. only the image features of the entire image 102 extracted by the image encoder 212 are aligned with the text features extracted by the text encoder 214, not the features of the image patches 104). Therefore, the projector operator 114 is used to project the patch-level features onto the latent space 116 (i.e. the output space of the image encoder 212). The classifier parameters may include, t_{n,c}, for the first text encoding 110 or the normal classifier, and classifier parameters, t_{a,c}, for the second text encoding 112 or the abnormal classifier. Herein, c is the class of the image 102. In particular, the text encoder 214 learns the classifier parameters for the different class names, such as the first text prompt 602 and the second text prompt 604 during the training. Further, the text encoder 214 encodes and projects the classifier parameters into the latent space 116 to generate the first text encoding 110 and the second text encoding 112. The projector operator 114 computes the vectors corresponding to the feature patches 104 of the image 102 and projects the vectors in the same latent space 116 having the first text encoding 110 and the second text encoding 112. During the training, the projector operator 114 learns to project vectors of abnormal feature patches closer to the encoding of the abnormal classifier, herein the second text encoding 112. Similarly, the projector operator 114 learns to project vectors of normal feature patches closer to the encoding of the normal classifier, herein the first text encoding 110.

Once the vectors of each of the feature patches 104 of the image are projected in the latent space 116, a presence or an absence of the anomaly 108 is detected. In an example, a posterior probability of the anomaly 108 is computed using a softmax layer with temperature scaling, T.

In an example, the processor 206 is configured to capture results of comparing the projection of each of the feature patches 104 with the first text encoding 110 and the second text encoding 112 as semantic scores. In this regard, a semantic score 812 is determined for the image 102 of the class c. The semantic score 812 is defined as:

$${S}_{s e m} ( {p}_{i} , c ) = \frac{exp ( {t}_{a c} \cdot )}{exp ( {t}_{n , c} ) + exp ( {t}_{a , c} \cdot )} \qquad ( 5 )$$

Herein, “⋅” denotes a dot product. To this end, a dot product between the projection, [symbol] , of the feature patch and the first text encoding, t_{n,c}, is computed to [symbol] produce a first score. Further, a dot product between the projection, [symbol] , of the feature [symbol] patch and the second text encoding, t_{a,c}, is computed to produce a second score. It may be noted from (5), the semantic score 812 is directly proportional to the dot product corresponding to the second score. Subsequently, when the second score, i.e., the projection, or similarity to the second text encoding, is higher, then the semantic score is higher, i.e., the feature patch under consideration tends to abnormal behavior.

One challenge of the semantic-based AD is to learn the classifier parameters t_{a,c} and t_{n,c} without explicit supervision since there are no training images of anomalies. To overcome this problem, the prior for normal/abnormal classification provided by the model 210 is utilized. This is implemented by feeding to a normal text prompt, denoted as vₙ, and an abnormal text prompt, denoted as vₐ to the text encoder 214 of the model 210. The normal text prompt and the abnormal text prompt may apply to all classes. For example, the vₙ may be set as “a” and vₐ may be set as “a broken”.

Further, to enhance the sensitivity of the semantic score 812 with respect to the image semantics, the normal and abnormal text prompts are complemented by an image class prompt, s_{c}. Based on the normal text prompt and the abnormal text prompt and the complemented image class prompt, the text encoder 214 may learn encodings for a pair of contradictory class names for different object classes during the training phase. In this manner, classifier parameters of the first text prompt and the second text prompt are learnt. Since the normal text prompt and the abnormal text prompt are defined, in certain cases, a pair of contradictory class names may be learnt for a new object class on the fly.

According to an example, an assumption is made that the class name of the object class is unknown. This is important to support the classes that are unknown to the model 210, or not present in the training dataset 402. In particular, instead of assuming a class name for an object class, a pseudo class name 414, s_{c}, is learned per class c. This is implemented by prompting the text encoder 214 with a prompt per class and learning prompts during the training phase (as described in the FIG. 4, FIG. 6 and FIG. 7).

In an example, a resulting set of semantic sensitive AD prompts is represented as: [symbol] ={[vⁿ; s_{c}], [v^{a}; s_{c}]}_{c}. The set of semantic sensitive AD prompts may be mapped to a set of classifier parameters {(t_{n,c}, t_{a,c})}generated by the text encoder 214 (denoted as T in equation (6)) of the model 210. The classifier parameters may be generated based on:

$${t}_{n , c} = T ( [ {v}^{n} ; {s}_{c} ] ) and {t}_{a , c} = T ( [ {v}^{a} ; {s}_{c} ] ) \qquad ( 6 )$$

Returning to the present example, the processor 206 is configured to combine the semantic scores, such as the semantic score 812 with the corresponding reconstruction scores, such as the reconstruction score 810 to produce combined scores (depicted as combined score 814). In an example, the combined score 814 may be generated by performing a linear operation, such as addition, multiplication, etc. on the semantic score 812 and the reconstruction score 810.

Further, the processor 206 is configured to detect the anomaly 108 based on the combined scores. For example, an anomaly in a feature patch may be determined based on the combined score generated for the particular feature patch. In this manner, the anomaly is also localized into corresponding feature patch(es).

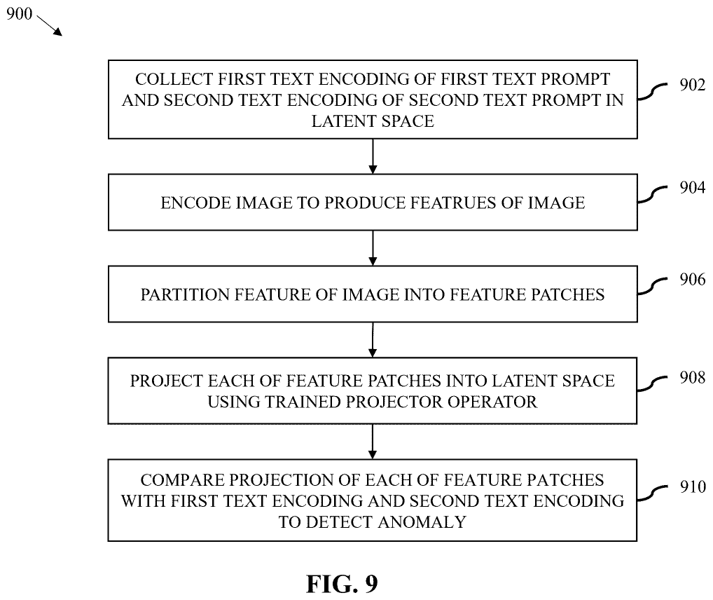

FIG. 9 shows a flowchart 900 of a method for detecting the anomaly 108 in the image 102, according to some other example embodiments of the present disclosure. The elements of the FIG. 9 are explained in conjunction with elements of the FIG. 1, FIG. z, FIG. 3, FIG. 4, FIG. 5, FIG. 6, FIG. 7, and FIG. 8.

At 902, the first text encoding 110 of the first text prompt 602 is collected in the latent space 116. Further, at 904, the second text encoding 112 of the second text prompt 604 is collected in the latent space 116. In an example, the processor 206 is configured to collect the first text encoding 110 and the second text encoding 112 from the text encoder 214. The text encoder 214 of the model 210 is used to extract the classifier parameters of the first text prompt 602 and the second text prompt 604 and generated the first text encoding 110 and the second text encoding 112 in the latent space 116. For example, the first text prompt 602 is a normal classifier, whereas the second text prompt 604 is contradictory to the first text classifier and is an abnormal classifier.

At 904, the image 102 is encoded to produce features 806 of the image 102. In an example, the processor 206 is configured to encode the image 102 using the image encoder 212 of the model 210.

At 906, the features 806 of the image 102 are partitioned into feature patches 104. In an example, the processor 206 is configured to partition the features 806 into the feature patches 104 using layers, l=1, . . . , L−1, of the image encoder 212. In an example, the feature patches 104 are fed to the RM 510 to cause the RM 510 to reconstruct the feature patches 104 into noise-free feature patches. Based on the reconstructed feature patches and corresponding feature patches 104, a reconstruction score 810 for each of the patch is determined.

At 908, each of the feature patches 104 is projected into the latent space 116 using the projector operator 114. In an example, the processor 206 is configured to use the projector operator 114 to perform semantic AD by projecting a vector of each of the feature patches in the latent space 116 in a semantic manner. For example, the semantic projection is done such that vectors of feature patches with anomaly or noisy features are projected closer to the second text encoding 112, while vectors of feature patches with normal behavior are projected closer to the first text encoding 110.

Further, at 910, the projection of each of the feature patches 104 is compared with the first text encoding 110 and the second text encoding 112 to detect the anomaly 108. In an example, the processor 206 is configured to generate a dot product of a distance between a projection of a feature patch and the first text encoding 110 with another dot product of a distance between the projection and the second text encoding 112. Further, the dot products are compared to assess whether the projection of the feature patch is closer to the first text encoding 110 or the second text encoding 112. Based on the comparison, a determination of presence or absence of an anomaly is determined. For example, when the projection is closer to the first text encoding 110 then the feature patch corresponding to the projection is considered to be normal, and vice-versa. In an example, based on the dot products for the projection, a semantic score 812 is determined for the projection. Similarly, semantic scores are generated for projections of each of the feature patches 104.

In an example, a combined score 814 for each of the feature patches 104 is generated based on a combination of the corresponding reconstruction score 810 and the corresponding semantic score 812. Based on the combined score 814 for each of the feature patches 104, an anomaly in the corresponding feature patches 104 is detected. After the detection of the anomalous feature patches from the feature patches 104, a downstream task may be performed.

### Overview of Use Cases

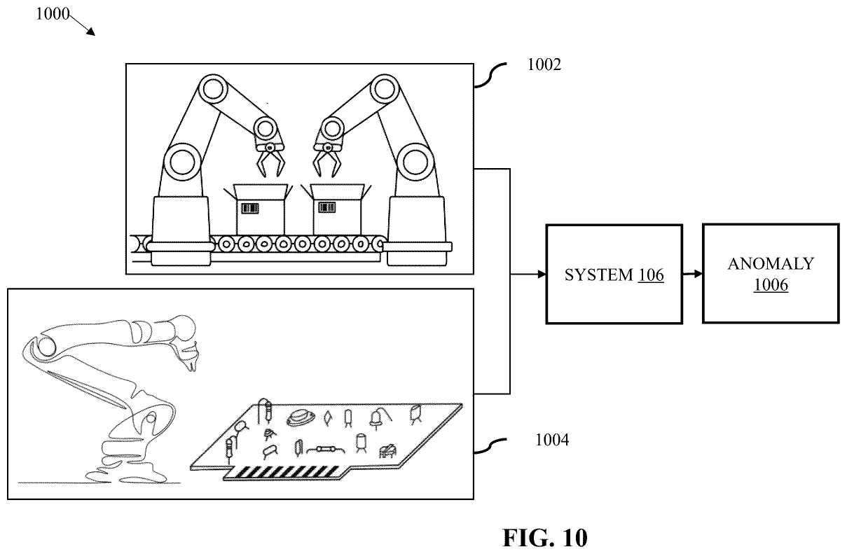

FIG. 10 illustrates a use case 1000 implementation of the system 106, according to some example embodiments of the present disclosure. The use case 1000 corresponds to a manufacturing or an industrial environment. In this regard, one or more machinery may be operating within the environment. Subsequently, a large number of products or objects are generated. In an example, the system 106 is configured to use LTAD by employing the model 210 and the RM 510 to detect and localize anomaly in the environment.

In an example, the system 106 may detect an anomaly 1006 that may correspond to defects or anomalies in manufactured products, such as identifying scratches, dents, or other imperfections in items on a production line. In another example, the system 106 may perform operations to replace or complement manual inspection processes with automated systems to detect the anomaly 1106 and enhance efficiency and accuracy.

In an illustrative example scenario, the industrial environment may include a first environment 1002 in which machineries are performing packaging related operations. Further, the industrial environment may include a second environment 1004 in which a machinery is performing PCB manufacturing operations. Further, different poses of an object in the production line are captured by a camera as one or more images. The camera may provide these images to the system 106, via a communication module. The system 106 may analyze the images to detect the anomaly 1006. Once the anomaly 1006 is detected, the processor 206 of the system 106 may generate instructions to trigger one or more actions. These actions may include, for example, a stopping action to stop the operations of the machinery, generating an alert notification to notify about the anomaly 1006, providing the detected for downstream processing, etc. For example, the downstream processing may be done to identify a type, a degree and/or a location of the anomaly 1006 with respect to the actual object or product.

In an example, alert notification may include an audio, a visual or a combination of audio-visual notification, such as “ANOMALY DETECTED!”. Additionally, or alternatively, the alert notification may be followed by a reminder with a message “TURN OFF”.

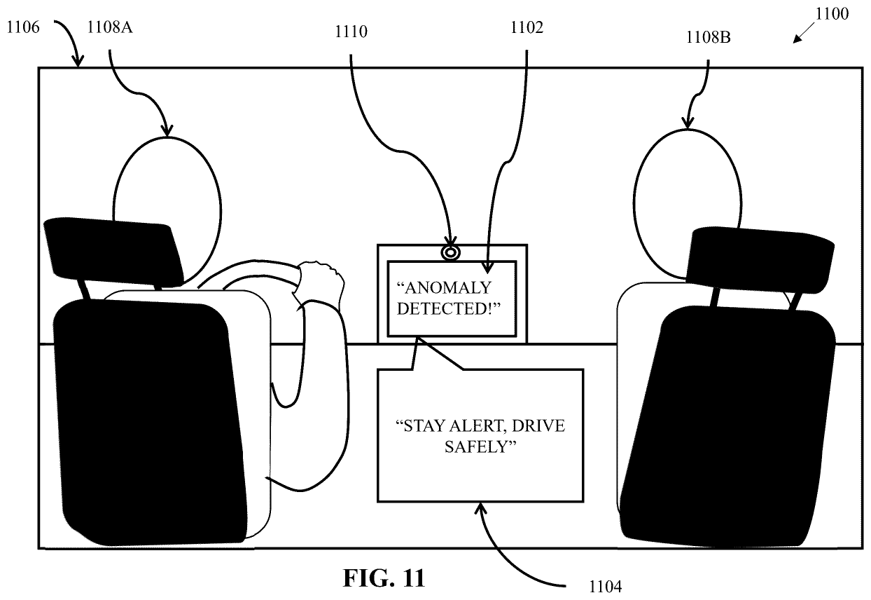

FIG. 11 illustrates a use case 1100 implementation of the system 106, according to some other example embodiments of the present disclosure. The use case 1100 corresponds to a vehicle driver assistance system. The system 106 may detect anomaly in poses of one or more occupants in a vehicle 1106, such as the occupant 1108A and the occupant 1108B (also referred to as the occupants 1108) in the vehicle 1106.

In an illustrative example scenario, the occupant 1108A driving the vehicle 1106 may turn away from looking straight to a road ahead. Such poses of turning away may be captured by a camera 1110. The camera 1110 may provide these poses to the system 106, via a vehicle driver assistance system 1102. The system 106 may detect these poses as anomaly poses and send an alert notification 1104 to the occupant 1108A based on the detected anomaly poses. The alert notification 1104 may include an audio, a visual or a combination of audio-visual notification, such as “ANOMALY DETECTED!”. Additionally, or alternatively, the alert notification 1104 may be followed by a reminder with a message “STAY ALERT, DRIVE SAFELY”.

In some cases, both the occupants 1108A and 1108B may move and exhibit poses that may be anomalous. In such cases, the system 106 may detect anomaly poses of each of the occupants 1108A and 1108B and generate the alert notification 1104 for each of the occupants 1108A and 1108B. In some example embodiments, the system 106 may recognize poses of the occupants 1108A and 1108B based on human action recognition techniques, human activity recognition techniques, or the like.

To this end, FIG. 10 and FIG. 11 describe implementation of the system 106 for anomaly detection in industrial environment and vehicle driver assistance system. However, this should not be construed as a limitation. In other cases, the system 106 may be implemented to detect anomalies in, for example, surveillance and security, medical imaging, quality controls, satellite image analysis, automated visual inspection, network intrusion detection, agriculture, autonomous vehicles, environmental monitoring, facility management, document verification, and so forth. Further, several downstream tasks may be performed based on anomaly detection. Examples of the downstream tasks may include, but are not limited to, root cause analysis, automated decision making, classification, alert and warning generation, process optimization, quality control feedback loop, predictive maintenance, supply chain adjustments, continuous improvement, feedback to system design, regulatory compliance, and customer communication.

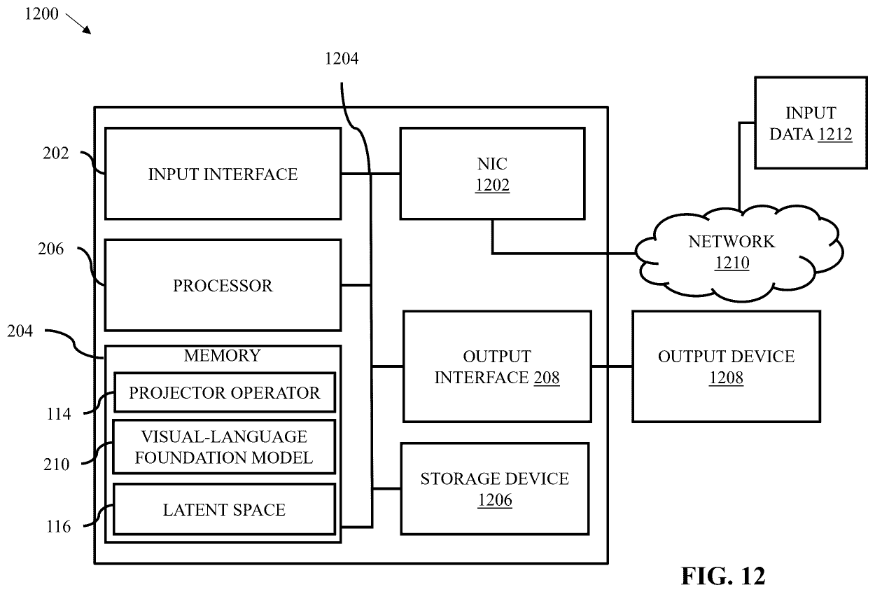

FIG. 12 shows an overall block diagram 1200 of the system 106, according to some example embodiments of the present disclosure. The system 106 includes a processor 206 configured to execute stored instructions, as well as a memory 204 that stores instructions that are executable by the processor 206. In some embodiments, the memory 204 is also configured to store the projector operator 114, the visual-language foundation model 210, and the latent space 116. The projector operator 114 corresponds to a binary classifier. Further, the latent space 116 includes classifier parameters and encodings of different text prompts or class names. For example, the latent space 116 includes at least two encodings, i.e., the first text encoding 110 and the second text encoding 112, such that the two encodings are contradictory.

In some example embodiments, the latent space 116 is accessed by the processor 206 using the model 210 to project feature patches into the latent space 116. The processor 206 may be a single core processor, a multi-core processor, a computing cluster, or any number of other configurations. The memory 204 can include random access memory (RAM), read only memory (ROM), flash memory, or any other suitable memory systems. The processor 206 is connected through a bus 1204 to an input interface 202. These instructions implement the method 900 for detection of the anomaly 108 in an image 102, such as the anomaly detection described in the use case 1000 of FIG. 10, the use case 1100 of FIG. 11, or the like.

In some implementations, the system 106 may have different types and combination of input interfaces to receive input data 1212. In one implementation, the input interface 202 may include audio-video receiver (AVR), a keyboard and/or pointing device, such as a mouse, trackball, touchpad, joystick, pointing stick, stylus, or touchscreen, among others.

Additionally, or alternatively, a network interface controller (NIC) 1202 may be adapted to connect the system 106 through the bus 1204 to a network 1210. Through the network 1210, the input data 1212 may be downloaded and stored within the memory 204 for storage and/or further processing.

Additionally, or alternatively, the system 106 may include a storage device 1206 for storing trained parameters of the pair of contradictory classifiers, annotated bag-of-poses for the anomaly detection in the input data 1212, or the like.

In addition to input interface 202, the system 106 may include one or multiple output interfaces 208 to output classification result rendered from the anomaly detection. For example, the system 106 may be linked through the bus 1204 to the output interface 208 adapted to connect the system 106 to an output device 1208. The output device 1208 may include a computer monitor, projector, a display device, a screen, mobile device, an audio device, or the like.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer-implemented method for detecting an anomaly in a patch of an image, wherein the method uses a processor coupled with stored instructions implementing steps of the method, comprising:
collecting a first text encoding of a first text prompt in a latent space;
collecting a second text encoding of a second text prompt in the latent space;
encoding the image to produce features of the image;
partitioning the features of the image into feature patches;
projecting each of the feature patches into the latent space using a projector operator, wherein the projector operator is trained to project normal feature patches of normal images closer to the first text encoding than to the second text encoding while projecting noisy feature patches of the normal images closer to the second text encoding than to the first text encoding; and
comparing the projection of each of the feature patches with the first text encoding and the second text encoding to detect the anomaly when the projection of a feature patch from the feature patches is closer to the second text encoding than to the first text encoding.

2. The method of claim 1, wherein an image encoder is trained to encode global features of the image into the latent space shared by the image encoder and a text encoder of a visual-language foundation model.

3. The method of claim 2, wherein the method further comprises:
collecting a plurality of normal images associated with a class;
encoding, using the image encoder, the plurality of normal images to produce features of the plurality of normal images;
processing, using an image decoder, the features of the plurality of normal images conditioned on a pseudo class name associated with the class, wherein the pseudo class name is the first text prompt; and
training the image decoder to learn the pseudo class name as the first text encoding.

4. The method of claim 3, wherein the method further comprises:
obtaining, using the text encoder, encodings of a pair of contradictory class names in the latent space, the pair of contradictory class names comprising the first text prompt and the second text prompt;
obtaining, using the image encoder, the features of the plurality of normal images;
partitioning the features of the plurality of normal images;
introducing noise to at least some of the partitioned features of the of the plurality of normal images to generate abnormal features; and
training the projector operator to project the partitioned features of the plurality of normal images and the abnormal features within the latent space, wherein the partitioned features of the plurality of normal images are closer to the first text prompt and the abnormal features are closer to the second text prompt.

5. The method of claim 4, wherein the method further comprises:
reconstructing, using a reconstruction model, the projected partitioned features of the plurality of normal images and the features for abnormal images;
generating a reconstruction loss and a semantic loss based on the reconstruction and the encodings of the pair of contradictory class names; and
re-training the projector operator and the reconstruction model to minimize the semantic loss and the reconstruction loss.

6. The method of claim 5, wherein the reconstruction model is a transformer.

7. The method of claim 3, wherein the image decoder is trained to learn encodings of a plurality of pseudo class names for a plurality of classes within the latent space.

8. The method of claim 2, wherein training dataset for the image encoder, the text encoder and the image decoder includes a plurality of images of the plurality of classes in a long-tailed distribution.

9. The method of claim 1, wherein the image encoder is a deep neural network including a sequence of layers, wherein each layer of the sequence of layers produces image features, and wherein the features of the image are formed by combining image features of different layers.

10. The method of claim 1, wherein the method further comprises:
determining a dot product between the projection of the feature patch with the first text encoding to produce a first score;
determining a dot product between the projection of the feature patch with the second text encoding to produce a second score; and
detecting the anomaly in the feature patch based on the first score and the second score.

11. The method of claim 1, wherein the first text prompt is a semantic name of a class of the image, and wherein the second text prompt is a modification of the first text prompt.

12. The method of claim 1, wherein the first text prompt is a semantic name of a class of the image, and wherein the second text prompt is a concatenation of a modifier word with the semantic name of the class of the image.

13. The method of claim 1, wherein the first text prompt is a semantic name of a class of the image learned for generating images of the class of the image with a visual-language foundation model.

14. The method of claim 1, wherein the method further comprises:
partitioning the image into patches corresponding to the feature patches;
reconstructing, using a reconstruction model, each of the feature patches of the image;
comparing the reconstructed feature patches with the corresponding partitions of the feature patches to produce reconstruction scores; and
detecting the anomaly based on the reconstruction scores.

15. The method of claim 14, wherein the method further comprises:
capturing results of comparing the projection of each of the feature patches with the first text encoding and the second text encoding as semantic scores;
combining the semantic scores with the corresponding reconstruction scores to produce combined scores; and
detecting the anomaly based on the combined scores.

16. A system for detecting an anomaly in a patch of an image, wherein the system comprises a processor and a memory having instructions stored thereon that cause the processor to:
collect a first text encoding of a first text prompt in a latent space;
collect a second text encoding of a second text prompt in the latent space;
encode the image to produce features of the image;
partition the features of the image into feature patches;
project each of the feature patches into the latent space using a projector operator, wherein the projector operator is trained to project normal feature patches of normal images closer to the first text encoding than to the second text encoding while projecting noisy feature patches of the normal images closer to the second text encoding than to the first text encoding; and
compare the projection of each of the feature patches with the first text encoding and the second text encoding to detect the anomaly when the projection of a feature patch from the feature patches is closer to the second text encoding than to the first text encoding.

17. The system of claim 16, wherein the system further comprises:
a text encoder trained to encode the first text prompt as the first text encoding and the second text prompt as the second text encoding in the latent space of a visual-language foundation model; and
an image encoder trained to encode global features of the image into the latent space shared by the image encoder and the text encoder of the visual-language foundation model.

18. The system of claim 17, wherein the image encoder is a deep neural network including a sequence of layers, wherein each layer of the sequence of layers produces image features, and wherein the features of the image are formed by combining image features of different layers.

19. The system of claim 16, wherein the instructions cause the processor to:
partition the image into patches corresponding to the feature patches;
reconstruct, using a reconstruction model, each of the feature patches of the image; and
compare the reconstructed feature patches with the corresponding feature patches of the image to produce reconstruction scores; and
detect the anomaly based on the reconstruction scores.

20. A non-transitory computer readable storage medium embodied thereon a program executable by a processor for performing a method, the method comprising:
collecting a first text encoding of a first text prompt in a latent space;
collecting a second text encoding of a second text prompt in the latent space;
encoding the image to produce features of the image;
partitioning the features of the image into feature patches;
projecting each of the feature patches into the latent space using a projector operator, wherein the projector operator is trained to project normal feature patches of normal images closer to the first text encoding than to the second text encoding while projecting noisy feature patches of the normal images closer to the second text encoding than to the first text encoding; and
comparing the projection of each of the feature patches with the first text encoding and the second text encoding to detect the anomaly when the projection of a feature patch from the feature patches is closer to the second text encoding than to the first text encoding.
